(19) United States
(12) Patent Application Publication
(10) Pub. No.: US 2023/0415270 A1
(43) Pub. Date: Dec. 28, 2023

(54) METHOD OF PRODUCING A NANOFLUID USING LASER ABLATION, CORRESPONDING NANOFLUID AND LASER ABLATION SYSTEM FOR MANUFACTURING NANOFLUIDS

(71) Applicant: University of South Africa, Pretoria (ZA)

(72) Inventors: Malek MAAZA, Cape Town (ZA); Saleh KHAMLICH, Cape Town (ZA)

(21) Appl. No.: 18/247,483

(22) PCT Filed: Sep. 30, 2021
(86) PCT No.: PCT/ZA2021/050056

§ 371 Date: Mar. 31, 2023

(30) Foreign Application Priority Data
Oct. 1, 2020 (ZA) 2020/06082

(51) Int. Cl. B23K 26/362; B23K 26/122; B23K 26/082; B01J 19/12

(52) U.S. Cl. CPC B23K 26/362; B23K 26/122; B23K 26/082; B01J 19/121; B22F 2998/10; B22F 2301/10; B22F 1/054

(57) ABSTRACT

The invention relates to a method of producing a nanofluid which includes laser ablating a target on a surface of which a liquid is flowing. The method includes the step of moving the target and a laser beam relative to each other. The method further includes the step of moving the target relative to the laser beam such that the laser beam scans across the surface of the target in the X or Z direction when the laser beam is oriented in the Y direction and the target faces the laser beam.

### FIELD OF THE INVENTION

This invention relates to a novel process for a One-step Mass-Production of various nanofluids in a modified version of laser ablation in open atmosphere.

### BACKGROUND TO THE INVENTION

It is known in the emerging field of nanofluids that such hybrid fluids, are gaining a global interest both from scientific & industrial point of view.

One of the technological application of nanoparticles that hold sound promise is their use as suspensions in various host fluids to enhance its thermal properties in general and specifically its heat transfer characteristics of such fluid. This would confront the challenging cooling problems in various thermal systems. The term “nanofluid” refers to a solid-liquid mixture or suspension produced by dispersing nano scaled metallic or nonmetallic solid particles in liquids.

The size of nanoparticles (usually less than 100 nm) in liquid mixtures gives them the ability to interact with liquids at the molecular level and so, conduct heat better than standard heat transfer fluids. Nanofluids can display enhanced heat transfer because of the combination of convection and conduction and additional energy transfer by particle dynamics and collision in addition to the elevated intrinsic heat conductivity of the nanoparticles themselves.

Suspensions of millimeter and micron-sized solid particles in liquids have been investigated for cooling and other applications but because of the relatively large sizes of the particles, they tend to cause abrasive action, which erodes system components. Also, they obstruct small flow channels and have the propensity to settle under gravity resulting in undesired pressure drops. Such a sedimentation phenomenon has to be minimized at a maximum.

In contrast, nanoparticles in fluids have low momentum, which greatly reduces abrasive wear and nanofluids can be described as colloids since a colloid is a substance made up of a system of particles that is insoluble yet remains in solution and dispersed in another fluid medium. The nanofluids, pioneered by Stephen S. Choi from the US Dept. of Energy, have been prepared by either single or multiple steps methodologies, namely:
1—Direct evaporation technique
2—Submerged arc nanoparticle synthesis technique
3—Laser ablation
4—Microwave irradiation
5—Polyol process
6—Phase-transfer method

The platinum group metals (PGMs) are six transitional metal elements that are chemically, physically, and anatomically similar. The PGMs are the densest known metal elements.

The six PGMs are:
1—Iridium (Ir)
2—Osmium (Os)
3—Palladium (Pd)
4—Platinum (Pt)
5—Rhodium (Rh)
6—Ruthenium (Ru).

For purposes of this definition, we include Gold and Silver to define a PGM.

It is accordingly an object of the present invention to provide an invention which relates to a novel laser ablation process employing a one-step mass production of nano particles from metallic, oxide, carbide and nitride targets which can be made nanofluids, in various liquids such as oils, H₂O, Ethylene Glycol (EG), and which nanofluids have enhanced thermal conductivity.

### SUMMARY OF THE INVENTION

According to a first aspect of the invention there is provided a method of producing a nanofluid, the method including laser ablating a target on a surface of which a liquid is flowing.

In an embodiment, the method may include moving the target and a laser beam relative to each other, preferably moving the target relative to the laser beam such that the laser beam scans across the surface of the target in the X and/or Z direction when the laser beam is oriented in the Y direction and the target faces the laser beam.

In an embodiment, the liquid may be continuously flowing on the surface of the target that is being laser ablated, and the liquid may be arranged to flow on the target at a predefined speed so as to maintain a predefined thickness of the liquid flowing on the target.

In an embodiment, the liquid may be heated to a predefined temperature.

In an embodiment, the liquid may be in the form of any one or more of the group including water, Castro oil, engine oil, Rubbia oil or the like.

In an embodiment, the target may be in the form of any one or more of the group including a metallic target, an oxide target, a nitride target, a carbide target or the like. More preferably, the metallic target may be in the form of non-oxidized but pristine metals, based on platinum group metals (PGMs). Yet further, the metallic target may be in the form of Cu and/or Al. Still further, the oxide target may be in the form of oxidized metals which may be selected from the group including CuO Al₂O₃, TiO₂, MgO or the like. Further still the nitride target may be in the form of TiN. Furthermore, the carbide target may be in the form of TiC and/or WC.

In an embodiment, the method may include collecting the liquid carrying laser ablated particles, wherein the laser ablated particles are in suspension in the collected liquid, wherein the liquid and suspended laser ablated particles define the nanofluid.

In an embodiment, the method may include laser ablating the target in an open atmosphere.

According to a second aspect of the invention, there is provided a nanofluid manufactured according to the method of the first aspect of the invention.

According to a third aspect of the invention, there is provided a laser ablation system for manufacturing nanofluids, the system including:
a laser beam source for producing a laser beam;
a target that is arranged to be in the path of the laser beam; and
a liquid source for discharging liquid on a surface of the target that is arranged to be laser ablated.

In an embodiment, the system may comprise a series of outlets in fluid communication with the target, for discharging the liquid from the liquid source onto the surface of the target that is arranged to be laser ablated.

In an embodiment, the system may comprise means for adjusting a rate at which the liquid is discharged on the surface of the target.

In an embodiment, the system may comprise a heating means for heating the liquid that is arranged to be discharged on the surface of the target.

In an embodiment, the system may comprise a collector that is arranged to collect the liquid flowing across the target, the liquid being arranged to carry laser ablated particles from the target.

In an embodiment, the system may comprise a computer system that is coupled to a displacement means, the computer system and displacement means being arranged to displace the target and laser relative to each other, preferably displace the target relative to the path of the laser beam so as to enable the laser beam to scan across the surface of the target and accordingly systematically scan the surface of the target as the laser beam is ablating the target.

### BRIEF DESCRIPTION OF THE FIGURES

The objects and features of the present invention will become fully apparent from following the description taken in conjunction with the accompanying drawings. Undertaking that these drawings depict only typical embodiments of the invention and are therefore, not to be considered limiting its scope, the invention will be described and explained with additional specific detail through the use of the accompanying drawings in which:

In the drawings:

FIG. 1 shows a laser ablation system for producing nanofluids in accordance with the invention.

FIG. 2 illustrates a typical transmission electron microscopy of nano-scaled Cu nanoparticles made within the described process whereby the Z-X moving target of Cu was covered with a flowing laminar film of standard Engine oil;

FIG. 3 illustrates a typical high-resolution transmission electron microscopy of nano-scaled Cu nanoparticles made within the described process;

FIG. 4 shows the thermal conductivity of the Cu Nanosuspensions in standard Engine oil and that of pure Engine oil measured by standard Pt wire technique; and

FIG. 5 shows the thermal conductivity of the Cu & Al Nanosuspensions in standard Transmission oil and that of pure Transmission oil measured by standard Pt wire technique;

FIG. 6 shows the thermal conductivity of the Cu & Al Nanosuspensions in standard Motui oil and that of pure Motui oil measured by standard Pt wire; and

FIG. 7 shows the thermal conductivity of the Cu & Al Nanosuspensions in standard Castro oil and that of pure Castro oil measured by standard Pt wire.

### DETAILED DESCRIPTION OF THE INVENTION

While various inventive aspects, concepts and features of the invention may be described and illustrated herein as embodied in combination in the exemplary embodiments, these various aspects, concepts, chemical compositions and features may be used in many alternative embodiments, either individually or in various combinations and sub-combinations thereof. Unless expressly excluded herein, all such combinations and sub-combinations are intended to be within the scope of the present invention. Still further, while various alternative embodiments as to the various aspects, concepts and features of the invention—such alternative structures, configurations, methods, chemical compositions and components, alternatives as to form, fit and function, and so on may be described herein. Such descriptions are not intended to be a complete or exhaustive list of available alternative embodiments, whether presently known or later developed.

Those skilled in the art may readily adopt one or more of the inventive aspects, concepts of features into additional embodiments and uses within the scope of the present invention even if such embodiments are not expressly disclosed herein. Still further, exemplary or representative values and ranges may be included to assist in understanding the present disclosure; however, such values and ranges are not to be construed in a limiting sense and are intended to be critical values or ranges only if so expressly, stated. Moreover, while various aspects, features and concepts may be expressly identified herein as being inventive or forming part of an invention, such identification is not intended to be exclusive but rather there may be inventive aspects, concepts and features that are fully described herein without being expressly identified as such or as part of a specific invention.

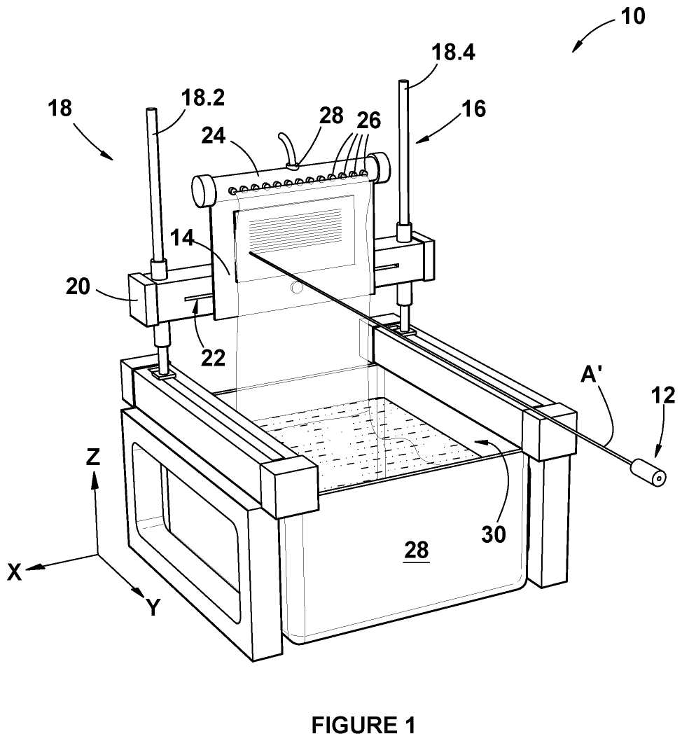

As can be seen in FIG. 1 of the drawings, there is provided a laser ablation system designated generally by reference numeral 10. The system 10 comprises a laser beam source 12 that is shown arranged in the Y direction and facing a substantially rectangular or cuboid target 14. The target 14 is fitted to a displacement means 16, comprising a pair of upright arms 18; an elongate support 20 that is fitted between the pair of upright arms 18; the support 20 defining a longitudinal recess 22 that accommodates a complementary member (not shown) on the target 14, which complementary member (not shown) is arranged to connect the target 14 to the support 20, and is further arranged to slide within the recess to allow the target to move relative to the support in the X-direction relative to the beam path of the laser beam emitted by the laser source 12 in the Y-direction; and an actuator (now shown) such as motors (not shown) which are arranged to displace/translate the support 20 along the arms 18.2, 18.4 in the Z direction relative to the beam path A′ of the laser beam emitted by the laser source 12 in the Y-direction, and further arranged to displace the target 14 relative to the support 20 in the X-direction through sliding movement of the complementary member (not shown) in the recess 22.

The system 10 comprises a computer system (not shown) that comprises a processor (not shown) and a memory device (not shown) containing instructions which are arranged to cause the displacement means 16 to displace the target 14 in the X and Z directions in a predefined sequence so as to enable the laser beam to scan across the surface of the target 14 facing the laser beam and enable the laser beam to ablate the surface of the target 14 in contact with the laser beam.

The system 10 further comprises a conduit 24 defining a series of longitudinally spaced outlets 26 which are in flow communication with the target 14, and which are arranged to discharge a liquid that is received through the inlet 28 on the conduit 24, onto the surface of the target 14 that is facing in the direction of the beam path A′. The system 10 further comprises a liquid source (not shown) which is arranged to provide the liquid into the inlet 28, which liquid is arranged to be discharged onto the surface of the target 14 via the outlets 26. The liquid flows on the surface of the target in a controlled laminar flow preferably forming a moving thin coating while the ablation is taking place at the interface of the liquid and target.

The memory device (not shown) may be further arranged to cause the processor (not shown) to adjust the rate of flow of the liquid discharged onto the surface of the target 14 via the outlets 26, so as to maintain a laminar flow of the liquid across the surface of the target 14 and also to maintain a minimal thickness of the interface defined between the liquid and surface of the target 14. Accordingly, the instructions in the memory device may be arranged to correspond to a liquid type and target type that is used in the laser ablation system 10. For example, there may be predefined instructions for a target that is a carbide and a corresponding liquid that is used on carbide targets so as to ensure that a predefined flow of liquid is maintained across the surface of the target that is to be ablated.

The system 10 further comprises a heating means (not shown) which is arranged to heat the liquid to a predefined temperature to adjust the viscosity of the liquid to a predefined viscosity that is appropriate for maintaining a predefined thickness or coating thickness of the liquid.

Furthermore, the system 10 comprise a collector 28 that is disposed below the target 14 and is in fluid communication with the target 14 to collect the liquid dripping or flowing from the target 14, the liquid carrying particles of the target 14 that have been laser ablated by the laser beam.

The liquid collected in the collector 28 defines the nanofluid in accordance with the invention, with the ablated particles being in suspension in the liquid, and preferably being uniformly dispersed in the liquid. The formed nanoparticles are not agglomerated & are suspended in the nanofluid for a long period of time minimizing the gravitational settlement phenomena.

The target can be a metallic target, an oxide target, a nitride target or a carbide target. The nature of the laser ablating source is determined by the absorption coefficient of the target material. The liquid should be heated if needed to modify its viscosity allowing a laminar flow over the target in order to avoid any substantial defocusing of the laser beam reaching the target.

In use, the laminar liquid flow and the thin thickness of the fluid on the X-Z moving target ensures that the laser beam is not geometrically affected at the liquid-target interface. While the target is ablated, the formed nanoparticles (i.e. ablated particles from the target) are dragged/displaced by the moving liquid film creating the targeted nanofluid which is collected at the bottom of the target in the collector 28. The target 14 is arranged to be moved in the X-Z direction to ensure ablation of fresh surface at any laser spot-target interaction. As highlighted in FIG. 1, The host fluid (i.e. the liquid), typically heated slightly to reduce its viscosity during the ablation process, is supplied to the target 14 at a predefined speed ensuring a regular continuous thin layer of host fluid coating while flowing continuously on the target. The wavelength of the laser is defined by the maximum of absorption of the target material. The fluence & rate repetition of the laser as well as the speed of X-Z of the target 14 determine the concentration of the then formed nanofluid. In the case of H2O based nanofluids, direct oxidation of the metallic formed nanoparticles can take place as in the standard LLSI/PLAL.

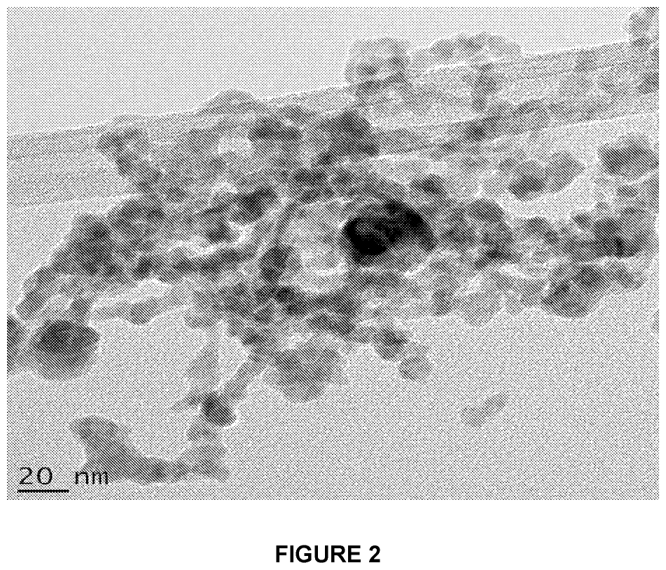

FIG. 2 illustrates a typical transmission electron microscopy of nano-scaled Cu nanoparticles made within the described process whereby the Z-X moving target of Cu was covered with a flowing laminar film of standard Engine oil.

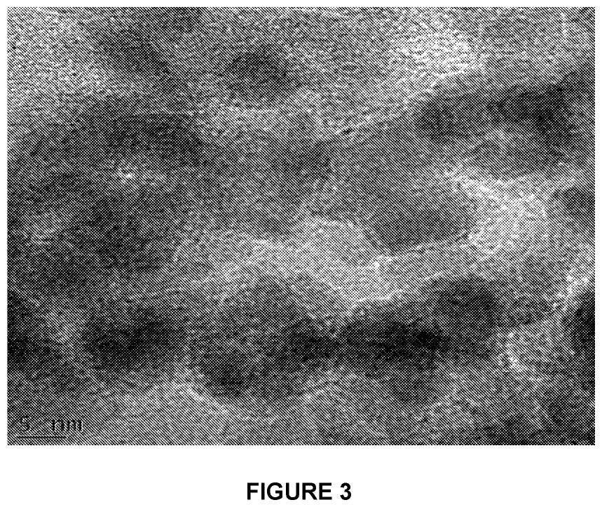

FIG. 3 illustrates a typical high resolution transmission electron microscopy of nano-scaled Cu nanoparticles made within the described process whereby the Z-X moving target of Cu was covered with a flowing laminar film of standard Engine oil. While mainly crystalline in structure, the Cu Nanoparticles exhibit various crystallographic orientations with a shell core morphology, a crystalline core & an amorphous shell coating.

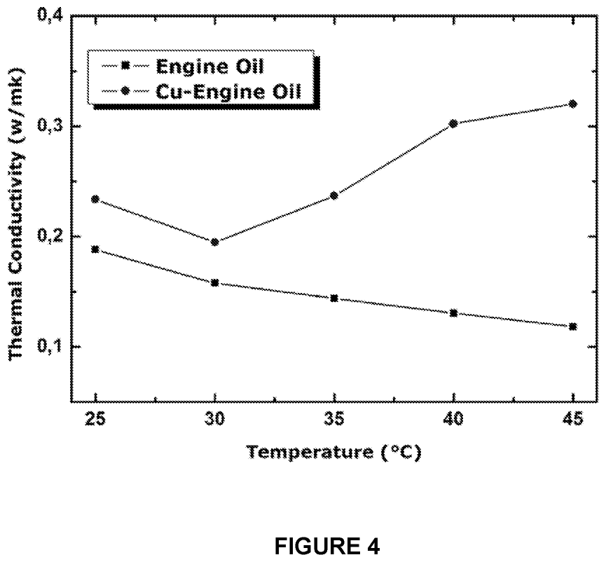

FIG. 4 shows the thermal conductivity of the Cu Nanosuspensions in standard Engine oil and that of pure Engine oil measured by standard Pt wire technique. While the thermal conductivity of Engine oil decreases with Temperature, the thermal conductivity of Cu-Engine oil nanofluid increases. The thermal conductivity at 45 Celsius is close to 200%.

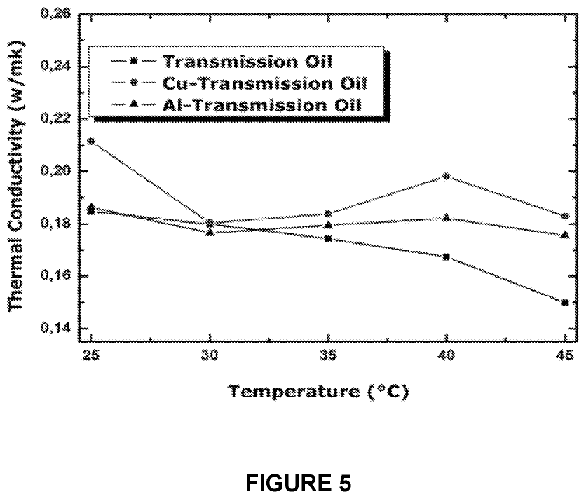

FIG. 5 shows the thermal conductivity of the Cu & Al Nanosuspensions in standard Transmission oil and that of pure Transmission oil measured by standard Pt wire technique. While the thermal conductivity of Transmission oil decreases with Temperature, the thermal conductivity of Cu-Transmission oil and Al Transmission oil nanofluid increases. The thermal conductivity at 45 Celsius is close to 22% for the Cu— Transmission oil while about 17% for Al— Transmission oil nanofluid.

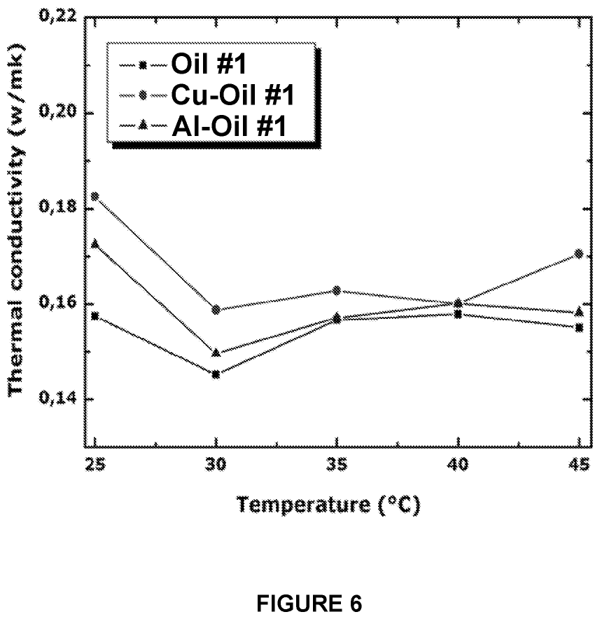

FIG. 6 shows the thermal conductivity of the Cu & Al Nanosuspensions in standard Motui oil and that of pure Motui oil measured by standard Pt wire technique. While the thermal conductivity of Motui oil decreases with Temperature, the thermal conductivity of Cu— Motui oil and Al-Motui oil nanofluid increases.

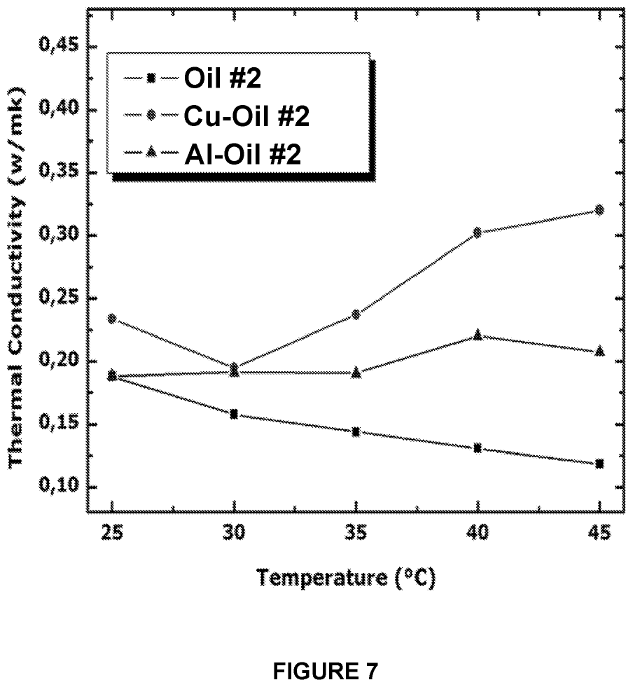

FIG. 7 shows Thermal conductivity of the Cu & Al Nanosuspensions in standard Castro oil and that of pure Castrol oil measured by standard Pt wire technique. While the thermal conductivity of Castrol oil decreases with Temperature, the thermal conductivity of Cu-Castrol oil and Al Engine oil nanofluid increases. The thermal conductivity at 45 Celsius is close to 200% for the Cu— Castrol oil while about 193% for Al— Castrol oil nanofluid.

As depicted in FIG. 1, the laser ablation system has the following advantages:
(i) it is a one step process of forming nanofluids;
(ii) results in mass production & hence industrial production;
(iii) potential of fabrication of nanofluids from various target materials such as metals, oxides, nitrides, carbides;
(iv) no vacuum required to produce the nanofluids;
(v) the Nanoparticles are not agglomerated & are suspended in the nanofluid for a long period of time minimizing the gravitational settlement phenomena;
(vi) the system can be integrated effortlessly to various laser sources operating at various temporal regimes & various spectral ranges to optimize the rate of ablation by tuning the laser-matter optical absorption.

1. A method of producing a nanofluid which includes laser ablating a target on a surface of which a liquid is flowing.

2. The method as claimed in claim 1 wherein said method includes the step of moving the target and a laser beam relative to each other.

3. The method as claimed in claim 2 wherein said method includes the step of moving the target relative to the laser beam such that the laser beam scans across the surface of the target in an X or Z direction when the laser beam is oriented in a Y direction and the target faces the laser beam.

4. The method as claimed in claim 1 wherein the liquid is continuously flowing on the surface of the target that is being laser ablated, and the liquid is arranged to flow on the target at a predefined speed so as to maintain a predefined thickness of the liquid flowing on the target.

5. The method as claimed in claim 1 wherein the liquid is heated to a predefined temperature.

6. The method as claimed in claim 1 wherein the liquid is in the form of any one or more of the group including water, Castro oil, engine oil, or Rubbia oil.

7. The method as claimed in claim 1 wherein the target is in the form of any one or more of the group including a metallic target, an oxide target, a nitride target, or a carbide target.

8. The method as claimed in claim 7 wherein the metallic target is in the form of non-oxidized but pristine metals, based on platinum group metals (PGMs).

9. The method as claimed in claim 7 wherein the metallic target is in the form of Cu or Al.

10. The method as claimed in claim 7 wherein the oxide target is in the form of oxidized metals.

11. The method as claimed in claim 10 wherein the oxidized metals are selected from the group including CuO Al2O3, TiO2, or MgO.

12. The method as claimed in claim 7 wherein the nitride target is in the form of TiN.

13. The method as claimed in claim 7 wherein the carbide target is in the form of TiC or WC.

14. The method as claimed in claim 1 wherein said method includes the step of collecting the liquid carrying laser ablated particles, wherein the laser ablated particles are in suspension in the collected liquid, wherein the liquid and suspended laser ablated particles define the nanofluid.

15. The method as claimed in claim 1 wherein said method includes the step of laser ablating the target in an open atmosphere.

16. A nanofluid manufactured according to a method as claimed in claim 1.

17. A laser ablation system for manufacturing nanofluids, comprising:
a laser beam source for producing a laser beam;
a target that is arranged to be in a path of the laser beam; and
a liquid source for discharging liquid on a surface of the target that is arranged to be laser ablated.

18. The laser ablation system as claimed in claim 17 comprising a series of outlets in fluid communication with the target, for discharging the liquid from the liquid source onto the surface of the target that is arranged to be laser ablated.

19. The laser ablation system as claimed in claim 17 comprising means for adjusting a rate at which the liquid is discharged on the surface of the target.

20. The laser ablation system as claimed in claim 17 comprising a heating means for heating the liquid that is arranged to be discharged on the surface of the target.

21. The laser ablation system as claimed in claim 17 comprising a collector that is arranged to collect the liquid flowing across the target, the liquid being arranged to carry laser ablated particles from the target.

22. The laser ablation system as claimed in claim 17 comprising a computer system that is coupled to a displacement means, the computer system and displacement means being arranged to displace the target and laser relative to each other.

23. The laser ablation system as claimed in claim 22 wherein the computer system and displacement means are arranged to displace the target relative to the path of the laser beam so as to enable the laser beam to scan across the surface of the target and accordingly systematically scan the surface of the target as the laser beam is ablating the target.
